(19) United States
(12) Patent Application Publication
(10) Pub. No.: US 2008/0118067 A1
(43) Pub. Date: May 22, 2008

(54) Method and apparatus for performing ciphering in a wireless communications system

(75) Inventor: Sam Shiaw-Shiang Jiang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 11/984,790

(22) Filed: Nov. 21, 2007

Related U.S. Application Data
(60) Provisional application No. 60/860,223, filed on Nov. 21, 2006.

(51) Int. Cl. H04K 1/00

(52) U.S. Cl. 380/270

(57) ABSTRACT

A method for performing ciphering in a wireless communications system includes performing a first ciphering procedure for a first Non-Access Stratum message to get a second Non-Access Stratum message, generating a Radio Resource Control message, which is not ciphered, in a Radio Resource Control layer, combining the second Non-Access Stratum message with the Radio Resource Control message to form a first concatenated message, performing a second ciphering procedure for both the NAS message and the RRC message within the first concatenated message to get a second concatenated message, and transmitting the second concatenated message.

### CROSS REFERENCE TO RELATED APPLICATIONS

This application claims the benefit of U.S. Provisional Application No. 60/860,223, filed on Nov. 21, 2006 and entitled “Security structure for LTE”, the contents of which are incorporated herein by reference.

### BACKGROUND OF THE INVENTION

1. Field of the Invention

The present invention relates to a method and apparatus for performing ciphering in a wireless communications system, and more particularly, to a method and apparatus for accurately performing ciphering in the wireless communications system so as to enhance information security.

2. Description of the Prior Art

The third generation (3G) mobile telecommunications system provides high frequency spectrum utilization, universal coverage, and high quality, high-speed multimedia data transmission, and also meets all kinds of QoS requirements simultaneously, providing diverse, flexible, two-way transmission services and better communication quality to reduce transmission interruption rates. According to the related protocol specifications, a protocol stack of the 3G mobile telecommunications system can be segmented into access stratum (AS) and non-access stratum (NAS). The AS comprises a Radio Resource Control (RRC), Radio Link Control (RLC), Media Access Control (MAC), Packet Data Convergence Protocol (PDCP), Broadcast/Multicast Control (BMC) and other sub-layers of different functions. Those skilled in the art are familiar with the operation of the above-mentioned sub-layers; therefore, they will not be further mentioned.

Long Term Evolution wireless communications system (LTE system), an advanced high-speed wireless communications system established upon the 3G mobile telecommunications system, supports only packet-switched transmission, and tends to implement both Medium Access Control (MAC) layer and Radio Link Control (RLC) layer in one single communication site, such as in Node B alone rather than in Node B and RNC (Radio Network Controller) respectively, so that the system structure becomes simpler.

A complete protocol specification is accomplished with lasting discussion, editing, and modification. Now, parts of the LTE structure are under Technical Report (TR) stage, meaning that the related protocol specifications are not finished. Therefore, many functions are still For Further Study (FFS).

According to the current system structure of the LTE system, the following can be summarized:

1. For User Plane, the layer structure is, from low to high, PHY (Physical layer), MAC, RLC, and PDCP.

2. For Control Plane, the layer structure is, from low to high, PHY, MAC, RLC, RRC, PDCP, and NAS.

3. For User Plane, ciphering is performed in PDCP.

4. For Control Plane, ciphering and IP for RRC messages are done in RRC and ciphering and IP for NAS messages are done in PDCP.

5. NAS messages may or may not be concatenated with RRC messages.

6. No IP from RRC for non-concatenated messages.

7. IP from RRC for concatenated NAS messages is FFS.

8. Protocol error detection and recovery function is performed in RLC.

Therefore, the prior art does not well specify the operation of ciphering from RRC for concatenated NAS messages.

### SUMMARY OF THE INVENTION

According to the present invention, a method for performing ciphering in a wireless communications system comprises performing a first ciphering procedure for a first Non-Access Stratum message to get a second Non-Access Stratum message, generating a Radio Resource Control message, which is not ciphered, in a Radio Resource Control layer, combining the second Non-Access Stratum message with the Radio Resource Control message to form a first concatenated message, performing a second ciphering procedure for both the NAS message and the RRC message within the first concatenated message to get a second concatenated message, and transmitting the second concatenated message.

According to the present invention, a method for performing ciphering in a wireless communications system comprises performing a first ciphering procedure for a first Non-Access Stratum message to get a second Non-Access Stratum message, generating a Radio Resource Control message, which is not ciphered, in a Radio Resource Control layer, combining the second Non-Access Stratum message with the Radio Resource Control message to form a first concatenated message, performing a second ciphering procedure for the Radio Resource Control message in the first concatenated message to get a second concatenated message, and transmitting the second concatenated message. The method is characterized by forming a first field in the first concatenated message for indicating a sequence number of the first concatenated message, forming a second field in the first concatenated message for indicating a position of the second Non-Access Stratum message corresponding to the first concatenated message, and not performing the second ciphering procedure for the first field and the second field.

According to the present invention, a communications device for accurately performing ciphering protection in a wireless communications system comprises a control circuit for realizing functions of the communications device, a processor installed in the control circuit, for executing a program code to command the control circuit, and a memory installed in the control circuit and coupled to the processor for storing the program code. The program code comprises performing a first ciphering procedure for a first Non-Access Stratum message to get a second Non-Access Stratum message, generating a Radio Resource Control message, which is not ciphered, in a Radio Resource Control layer, combining the second Non-Access Stratum message with the Radio Resource Control message to form a first concatenated message, performing a second ciphering procedure for all fields except a sequence number field of the first concatenated message to get a second concatenated message, and transmitting the second concatenated message.

According to the present invention, a communications device for accurately performing ciphering protection in a wireless communications system comprises a control circuit for realizing functions of the communications device, a processor installed in the control circuit, for executing a program code to command the control circuit, and a memory installed in the control circuit and coupled to the processor for storing the program code. The program code comprises performing a first ciphering procedure for a first Non-Access Stratum message to get a second Non-Access Stratum message, generating a Radio Resource Control message, which is not ciphered, in a Radio Resource Control layer, combining the second Non-Access Stratum message with the Radio Resource Control message to form a first concatenated message, performing a second ciphering procedure for the Radio Resource Control message in the first concatenated message to get a second concatenated message, and transmitting the second concatenated message. The program code is characterized by forming a first field in the first concatenated message for indicating a sequence number of the first concatenated message, forming a second field in the first concatenated message for indicating a position of the second Non-Access Stratum message corresponding to the first concatenated message, and not performing the second ciphering procedure for the first field and the second field.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 and FIG. 4 are flowcharts of processes according to embodiments of the present invention.

### DETAILED DESCRIPTION

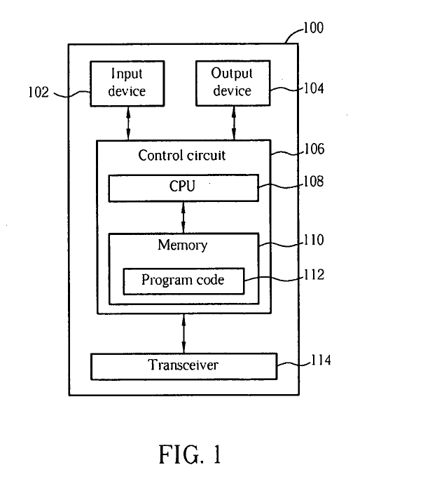

Please refer to FIG. 1, which is a functional block diagram of a communications device 100 in a wireless communications system. The wireless communications system is preferably the LTE system. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

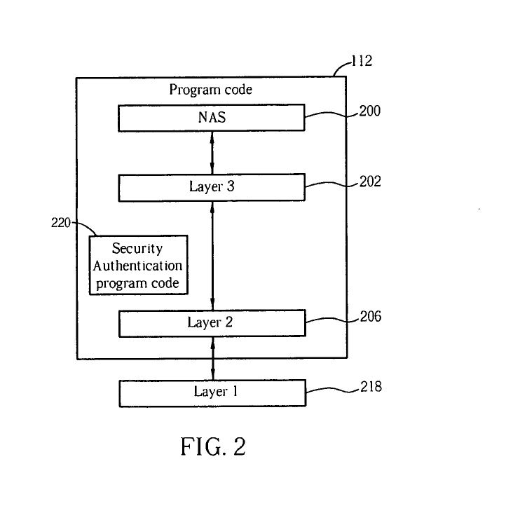

Please continue to refer to FIG. 2. FIG. 2 is a diagram of the program code 112 shown in FIG. 1. The program code 112 includes a Non Access Stratum (NAS) 200, a Layer 3 202, and a Layer 2 206, and is coupled to a Layer 1 218. The NAS 200 can generate NAS messages for realizing NAS applications. The Layer 3 202 is preferably composed of an RRC layer and a PDCP layer, for performing resource control. The Layer 2 206 performs link control, and the Layer 1 218 performs physical connections.

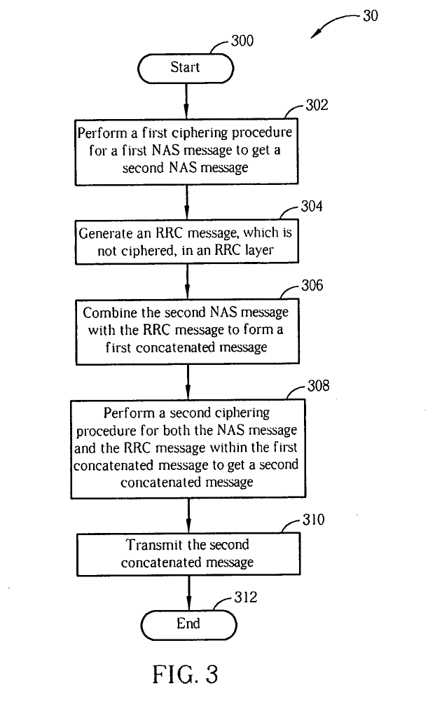

In order to enhance information security, the program code 112 can perform ciphering for messages, to protect user data and signaling information from being intercepted by unauthorized devices. In such a situation, the embodiment of the present invention provides a Security Authentication program code 220, for accurately performing ciphering. Please refer to FIG. 3, which illustrates a schematic diagram of a process 30. The process 30 is utilized for performing ciphering in a wireless communications system, and can be compiled into the Security Authentication program code 220. The process 30 comprises the following steps:
Step 300: Start.
Step 302: Perform a first ciphering procedure for a first NAS message to get a second NAS message.
Step 304: Generate an RRC message, which is not ciphered, in an RRC layer.
Step 306: Combine the second NAS message with the RRC message to form a first concatenated message.
Step 308: Perform a second ciphering procedure for both the NAS message and the RRC message within the first concatenated message to get a second concatenated message.
Step 310: Transmit the second concatenated message.
Step 312: End.

According to the process 30, after the concatenated message containing the RRC message and the NAS message is formed, the embodiment of the present invention performs the second ciphering procedure for both the NAS message and the RRC message within the concatenated message. Preferably, the first ciphering procedure is performed by the upper layer of the RRC layer, while the second ciphering procedure is performed by the RRC layer or its lower layer.

In such a situation, the second ciphering procedure is performed on both the NAS message and the RRC message in the concatenated message, so that extra field for discriminating the NAS message and the RRC message in the concatenated message is not necessary. Therefore, the second ciphering procedure becomes simple and does not use extra field. As a result, the deciphering procedure in the receiver can be simplified, so as to reduce deciphering errors.

Therefore, via the process 30, the embodiment of the present invention can accurately perform the ciphering procedure for the concatenated message containing the RRC message and the NAS message, simplify the deciphering procedure, reduce unnecessary field, so as to enhance information security, as well as transmission efficiency.

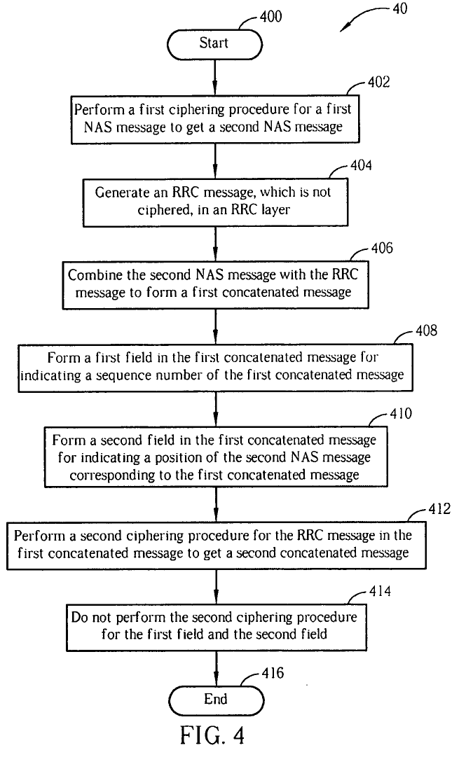

Please refer to FIG. 4, which illustrates a schematic diagram of a process 40. The process 40 is utilized for performing ciphering in a wireless communications system, and can be compiled into the Security Authentication program code 220. The process 30 comprises the following steps:
Step 400: Start.
Step 402: Perform a first ciphering procedure for a first NAS message to get a second NAS message.
Step 404: Generate an RRC message, which is not ciphered, in an RRC layer.
Step 406: Combine the second NAS message with the RRC message to form a first concatenated message.
Step 408: Form a first field in the first concatenated message for indicating a sequence number of the first concatenated message.
Step 410: Form a second field in the first concatenated message for indicating a position of the second NAS message corresponding to the first concatenated message.
Step 412: Perform a second ciphering procedure for the RRC message in the first concatenated message to get a second concatenated message.
Step 414: Do not perform the second ciphering procedure for the first field and the second field.
Step 416: End.

According to the process 40, after the concatenated message containing the RRC message and the NAS message is formed, the embodiment of the present invention only ciphers the RRC message in the concatenated message, and does not cipher the NAS message in the concatenated message again. As a result, unnecessary second-time ciphering on NAS message part is prevented. In such a situation, the feature of the process 40 is the addition of a second field in the concatenated message, for indicating the position of NAS message in the concatenated message. Then, the receiver can accurately decipher the concatenated message to get the original RRC message and NAS message. Preferably, the first ciphering procedure is performed by the upper layer of the RRC layer, while the second ciphering procedure is performed by the RRC layer or its lower layer.

Therefore, via the process 40, the embodiment of the present invention can accurately perform the ciphering procedure for the concatenated message containing the RRC message and the NAS message, so that the receiver can accurately perform deciphering, and thus information security can be enhanced.

In summary, the embodiment of the present invention provides variable implementations for ciphering protection of concatenated messages, so as to accurately perform ciphering protection, and enhance information security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing ciphering in a wireless communications system comprising:
performing a first ciphering procedure for a first Non-Access Stratum message to get a second Non-Access Stratum message;
generating a Radio Resource Control message, which is not ciphered, in a Radio Resource Control layer;
combining the second Non-Access Stratum message with the Radio Resource Control message to form a first concatenated message;
performing a second ciphering procedure for both the NAS message and the RRC message within the first concatenated message to get a second concatenated message; and
transmitting the second concatenated message.

2. The method of claim 1, wherein the first ciphering procedure is performed by an upper layer of the Radio Resource Control layer.

3. The method of claim 1, wherein the second ciphering procedure is performed by the Radio Resource Control layer.

4. The method of claim 1, wherein the second ciphering procedure is performed by a lower layer of the Radio Resource Control layer.

5. A method for performing ciphering in a wireless communications system comprising:
performing a first ciphering procedure for a first Non-Access Stratum message to get a second Non-Access Stratum message;
generating a Radio Resource Control message, which is not ciphered, in a Radio Resource Control layer;
combining the second Non-Access Stratum message with the Radio Resource Control message to form a first concatenated message;
performing a second ciphering procedure for the Radio Resource Control message in the first concatenated message to get a second concatenated message; and
transmitting the second concatenated message;
wherein the method is characterized by:
forming a first field in the first concatenated message for indicating a sequence number of the first concatenated message;
forming a second field in the first concatenated message for indicating a position of the second Non-Access Stratum message corresponding to the first concatenated message; and
not performing the second ciphering procedure for the first field and the second field.

6. The method of claim 5, wherein the first ciphering procedure is performed by an upper layer of the Radio Resource Control layer.

7. The method of claim 5, wherein the second ciphering procedure is performed by the Radio Resource Control layer.

8. The method of claim 5, wherein the second ciphering procedure is performed by a lower layer of the Radio Resource Control layer.

9. A communications device for accurately performing ciphering protection in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
performing a first ciphering procedure for a first Non-Access Stratum message to get a second Non-Access Stratum message;
generating a Radio Resource Control message, which is not ciphered, in a Radio Resource Control layer;
combining the second Non-Access Stratum message with the Radio Resource Control message to form a first concatenated message;
performing a second ciphering procedure for all fields except a sequence number field of the first concatenated message to get a second concatenated message; and
transmitting the second concatenated message.

10. The communications device of claim 9, wherein the first ciphering procedure is performed by an upper layer of the Radio Resource Control layer.

11. The communications device of claim 9, wherein the second ciphering procedure is performed by the Radio Resource Control layer.

12. The communications device of claim 9, wherein the second ciphering procedure is performed by a lower layer of the Radio Resource Control layer.

13. A communications device for accurately performing ciphering protection in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
performing a first ciphering procedure for a first Non-Access Stratum message to get a second Non-Access Stratum message;
generating a Radio Resource Control message, which is not ciphered, in a Radio Resource Control layer;
combining the second Non-Access Stratum message with the Radio Resource Control message to form a first concatenated message;
performing a second ciphering procedure for the Radio Resource Control message in the first concatenated message to get a second concatenated message; and
transmitting the second concatenated message;
wherein the program code is characterized by:
forming a first field in the first concatenated message for indicating a sequence number of the first concatenated message;
forming a second field in the first concatenated message for indicating a position of the second Non-Access Stratum message corresponding to the first concatenated message; and
not performing the second ciphering procedure for the first field and the second field.

14. The communications device of claim 13, the first ciphering procedure is performed by an upper layer of the Radio Resource Control layer.

15. The communications device of claim 13, wherein the second ciphering procedure is performed by the Radio Resource Control layer.

16. The communications device of claim 13, wherein the second ciphering procedure is performed by a lower layer of the Radio Resource Control layer.
